(19) United States
(12) Patent Application Publication
(10) Pub. No.: US 2010/0041814 A1
(43) Pub. Date: Feb. 18, 2010

(54) METHODS FOR PREPARING TOUGHENED EPOXY POLYMER COMPOSITE SYSTEMS

(75) Inventors: WILLIAM EDWARD STARNER, CHERRY HILL, NJ (US); JAMES EVERETT SHIRK, MT. LAUREL, NJ (US)

Correspondence Address: WOODCOCK WASHBURN LLP, CIRA CENTRE, 12TH FLOOR, 2929 ARCH STREET, PHILADELPHIA, PA, 19104-2891, US

(73) Assignee: CVC SPECIALTY CHEMICALS, INC, Moorestown, NJ (US)

(21) Appl. No.: 12/534,931

(22) Filed: Aug. 4, 2009

Related U.S. Application Data
(60) Provisional application No. 61/089,316, filed on Aug. 15, 2008.

(51) Int. Cl. C08K 3/34; C08L 63/00

(52) U.S. Cl. 524/445; 524/611

(57) ABSTRACT

The present invention relates to epoxy resin compositions and more particularly to providing methods for toughening such epoxy resin systems. The methods include mixing a liquid epoxy resin with a glycidyl terminated modifying polymer and copolymerizing the epoxy resin and glycidyl terminated modifying polymer such that a liquid or gel phase comprising the modifying polymer separates from a solidified epoxy polymer to form the epoxy polymer composite system.

### CROSS REFERENCE TO RELATED APPLICATIONS

This application claims the benefit of U.S. provisional patent application serial no. 61/089,316, filed Aug. 15, 2008, which is incorporated herein by reference in its entirety.

### TECHNICAL FIELD

The present invention relates to epoxy resin compositions and more particularly to providing methods for toughening such epoxy resin systems.

### BACKGROUND

Epoxy resins are monomers or oligomeric pre-polymers that react with curing agents, through a plurality of epoxide or oxirane functional rings, to yield high performance cured resins. Such cured resins are widely utilized as, for example, protective coatings for electrical insulation, composite matrix resins, and structural adhesives, due to their combination of desired chemical and physical characteristics, such as thermal and chemical resistance, adhesion and adhesion retention, and abrasion resistance. Indeed, for over fifty years epoxies have been one of the leaders in the adhesive and structural composite market.

Generally, liquid epoxy resins contain monomers or oligomeric pre-polymers which themselves contain more than two epoxide or oxirane functional rings, either through homopolymerization or through addition polymerization with one or more multifunctional epoxy curing agents. As a result, and unlike polymers formed from simpler difunctional “chain extending” monomers, epoxy resins form structures which are significantly cross-linked. While this imparts certain of their desirable chemical and physical characteristics, this also tends to form cured resins which are brittle. That is, brittle resins tend to crack and physically degrade when subjected to single or repetitive physical stresses.

Several approaches are known to mitigate the problems with brittleness. In one approach, chain extending (di-functional) dilutant monomers or oligomeric pre-polymers (so-called “modifiers”) are added to the liquid epoxy precursors before polymerization to form the epoxy polymer matrix. If, during the copolymerization, the dilutant monomers or oligomers incorporate into the epoxy network yielding a single solid phase, the effect of the addition is to reduce the crosslink density of the epoxy network. Such an approach is typically used when enhancements in flexibility, elasticity, or ductility are desired, but is not used to enhance adhesion or structural support. An example of a modifying polymer that is compatible in the premix and also in the cured formula would be a reactive diluent of low molecular weight such as a polyglycidyl ether or ester. Unfortunately, this reduction in crosslink density leads to the disadvantageous lowering of the glass transition temperature (Tg) of the resulting cured single phase resin. The glass transition temperature is the temperature at which the cured resin changes from a relatively strong, high modulus, hard state to a low modulus, pliable, elastic state. In general, if it is intended that the cured resin be strong at relatively high temperatures, then a relatively high glass transition temperature will be necessary.

Another approach to mitigating brittleness is to incorporate additives into the crosslinked matrix. For example, hollow or filled glass spheres, core shell particles, or separate, less brittle, “softer” elastomer polymer phases are known to improve the toughness of epoxy systems by this mechanism. The separate phases act like shock absorbers, dampening the effect of physical stresses on the polymer matrix. Alternatively, these additives prevent or reduce crack propagation within the matrix. That is, while microcracking may still occur, the deleterious effects of brittleness can be mitigated by intercepting and preventing the cracks from growing. However, most conventional modifiers are higher viscosity liquid or solid polymers that cause further thickening to the uncured epoxy formulation making handling more of a challenge. Similarly, the added phase may compromise the adhesion of the epoxy polymer to a substrate or cohesion to itself. To overcome this, so as to obtain specific properties, multiple modifiers are used, but more often than not, the targeted properties come at the expense of other, equally important properties.

A third approach is to use the principles of both of the first two approaches; that is, to add chain extending (di- or poly-functional) modifying polymers to the liquid epoxy precursors before polymerization, but in this case, the character of these modifying polymers is sufficiently different or the polymer is of sufficiently high molecular weight, such that when they co-polymerize with the epoxy, they phase separate from the matrix to form separate inclusions (the size and shape of which depend on the cure kinetics) within the final epoxy matrix. An example of such a modifier that is compatible in (miscible with) the pre-reaction mix but becomes incompatible (phase separates) during cure would be a carboxy-terminated butadiene acrylonitrile copolymer (CTBN) that may or may not be adducted with epoxy resin (described, for example, in Cech, J. and Kretow, R. The Effectiveness of Toughening Technologies on Multifunctional Epoxy Resin Systems, SPI Conference 2001; McGarry, F. J. and Willner, A. M. Toughening of an Epoxy Resins by an Elastomeric Second Phase, Res. Rept. R68-8, School of Engineering, Massachusetts Institute of Technology, Cambridge, Mass.1968; Sultan, J. N. and McGarry, F. J. Macrostructural Characteristics of Toughened Thermoset Polymers, Ibid, R69-59, 1969; and Rowe, E. H.; Siebert, A. R.; Drake, R. S. Mod. Plast. 1970 417, 110). CTBNs and their corresponding adducts with Bisphenol A epoxy resin are well known to the industry and are often used as a benchmark for epoxy modifier studies.

Glycidyl ethers of polyethers, polyesters, and butadiene or butadiene/acrylonitrile copolymers are known but have not been applied to toughen epoxy resin systems as described herein. For example, U.S. Pat. No. 3,057,809 discloses the glycidation of polyhydridic alcohols and dimerized fatty acids. U.S. Pat. No. 3,208,980 discloses the glycidation of carboxy terminated polydienes. U.S. Pat. No. 3,784,525 discloses the glycidation of carboxy terminated butadiene and butadiene/acrylonitrile copolymers. The disclosures of these patents are incorporated herein by reference.

Additionally, use of terminally glycidated polymerized fatty acids are known to toughen epoxy resin systems, but only where the glycidyl groups are attached by Bisphenol A type linkages. Use of higher molecular weight polyesters derived from the condensation reaction of dimerized fatty acid and a low molecular weight dioic acid with glycol have also been used as a means for toughening epoxy systems.

It would be desirable to have a lower viscosity liquid modifier thus allowing for easier handling or the addition of more inexpensive fillers. These modifiers may be compatible in the pre-reaction mix and either remain compatible or phase separate upon curing, or may be incompatible in the pre-reaction mix and stay incompatible upon curing. Also, methods are needed to improve the toughness of the epoxy polymer system which do not substantially lower its glass transition temperature.

### SUMMARY

In one embodiment, the present invention relates to a method for preparing a toughened epoxy polymer composite system, comprising reacting epiclorohydrin with a modifying polymer having at least two terminal proton donating functional groups to terminate the modifying polymer with at least two glycidyl ethers, mixing a liquid epoxy resin with the glycidyl terminated modifying polymer, and copolymerizing the epoxy resin and the glycidyl terminated modifying polymer such that a liquid or gel phase comprising the modifying polymer separates from a solidified epoxy polymer to form the epoxy polymer composite system, wherein the modifying polymer has a molecular weight of about 2000 daltons or greater.

In another embodiment, the modifying polymer is of the general formula

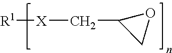

wherein R¹ comprises a polyether, polyester, polyacrylic, polyamide, polyolefin, polydiene, or polydiene/acrylonitrile copolymer, X is an ester, ether, amido or amino linkage, and n is 1-6.

Other embodiments of the invention relate to epoxy polymer composite systems prepared by the method described above.

The present invention may be understood more readily by reference to the following detailed description taken in connection with the accompanying examples, which form a part of this disclosure. It is to be understood that this invention is not limited to the specific products, methods, conditions or parameters described and/or shown herein, and that the terminology used herein is for the purpose of describing particular embodiments by way of example only and is not intended to be limiting of any claimed invention.

### DETAILED DESCRIPTION OF ILLUSTRATIVE EMBODIMENTS

According to the present invention, epoxy polymer systems may be toughened while maintaining acceptable glass transition temperatures. In one embodiment, this is accomplished by the use of certain glycidyl terminated modifying polymers that are added to the epoxy resin prior to curing, such as terminally glycidated polyethers, polyesters, polyacrylates, polyamides, polyolefins, polydienes, and butadiene or butadiene/acrylonitrile copolymers, and more preferably terminally glycidated oligomeric polyethers, polyesters, and butadiene or butadiene/acrylonitrile copolymers. The molecular weight of the modifying polymer is about 2000 daltons or above.

With respect to toughening an epoxy polymer system, the methods described herein provide a composite structure comprising a main epoxy polymer system, and also including a second, phase distinct modifying polymer, such that the properties of the composite are generally improved compared to that of the epoxy system without the modifying polymer. While not intended to be bound to any one theory, it is believed that the mechanism for toughening is the formation of a second, discrete phase of the modifying polymer, e.g., polyethers, polyesters, and butadiene or butadiene/acrylonitrile copolymers, within the epoxy matrix. Although these liquid materials are miscible or highly dispersed with the uncured epoxy resin prior to cure, they phase separate to form inclusions while the epoxy matrix cures.

Although the invention has been exemplified with glycidated Bisphenol A type epoxy resins, the invention is not limited to this system, and may include other epoxy systems, for example, systems based on Bisphenol F.

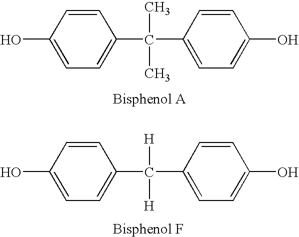

One feature of this invention is that the final composite contains a separate liquid or gel phase associated with the modifying polymer, and this is believed to be important in retaining the structural integrity of the final polymer material.

The structures of epoxy resins and epoxy polymers are well known in the industry. See, for example, Ashcroft, W. R., Chemistry and Technology of Epoxy Resins, Ellis, B. Ed.; Blackie Academic & Professional; London, 1993; Lee, H. and Neville, K., Handbook of Epoxy Resins, McGraw-Hill Book Company, New York; and May, C. A., Epoxy Resins Chemistry and Technology, Second Edition, Revised and Expanded, Marcel Dekker, Inc., New York, 1988. The disclosures of the various types of epoxy precursors and systems in these references are incorporated herein by reference.

As used herein, the term “epoxy resin” refers to monomeric or oligomeric thermosetting resins whose reactivity depends on two or more epoxide moieties within the monomeric or oligomeric resin structure. Oligomeric resins typically have from about 0 to about 6 repeating monomer units. Epoxy resins react with curing agents, through the epoxy functional ring, to yield high performance cured resins. Epoxy resins generally include a plurality of epoxy or oxirane groups. The epoxy groups can react to form a network, typically either through homopolymerization or through addition polymerization with an epoxy curing agent. Such curing agents (or mixture of agents) typically having three or more reactive sites available for reaction with oxirane groups. As a result of such a structure, an epoxy curing agent can generate a network, i.e., a significantly cross-linked system.

Epoxy curing agents are to be distinguished from compounds referred to herein as merely chain extension agents. As used herein, the term “chain extension agent” is meant to refer to a compound which has only two sites capable of reaction with the epoxy or oxirane groups. During polymerization, a chain extension agent will typically become lodged between epoxy resin chains, extending the same. Little cross-linking occurs, however, since the chain extension agent does not include a third reactive site.

An example of an epoxy curing agent is a diprimary amine, which is capable of reacting with four epoxy groups. Typical chain extension agents include diphenols, such as resorcinol or Bisphenol A. In general, most commercial epoxy resin systems are the ones based on the glycidation of Bisphenol A:

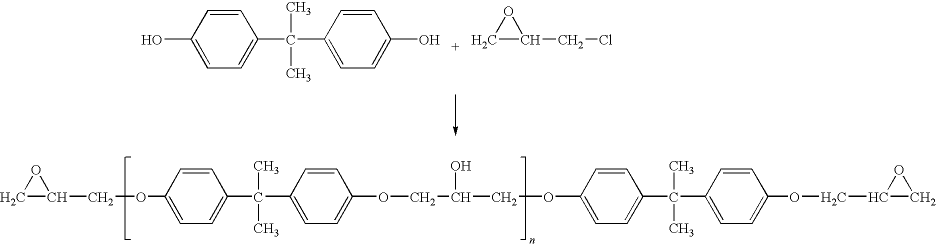

In the context of the present invention, the use of glycidyl ethers as the functional group on the modifying polymer provides process benefits and final product features that are surprising and unexpected. Such glycidyl functionalization can be achieved, for example, by reacting epichlorohydrin onto terminal carboxylic acids, alcohols, thioacids, thiols, amines, amides, or any other group so able to react with this type of chemistry, and known by those skilled in the art. For example, terminal groups of the general formula R—X can be used, where X is —COOH, —OH, —SH, —C(O)SH, —C(S)SH, —NH(R), or —C(O)NH(R), where R is H or C₁₋₄ alkyl.

As used herein, “poly-functional” describes those compounds containing active hydrogen in accordance with the Zerevitanov test described by C. R. Noller, Chemistry of Organic Compounds, Chapter 6, pages 121-122 (1957). The term “poly-functional” further means a compound having an average functionality greater than 1, preferably greater than 1.8, and most preferably about 2.0 or greater, but less than about 6, preferably less than about 4, and most preferably about 3 or less. It is understood to include compounds that have, for example, (i) alcohol groups on primary, secondary, and tertiary carbon atoms, (ii) carboxylic acids, (iii) primary and secondary amines, (iv) primary and secondary amides, (v) mercaptans, and (vi) mixtures of these functional groups.

The end group structures on the modifying polymer of the present invention are structurally depicted as:

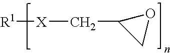

wherein R¹ comprises a polyether, polyester, polyamide, polyethylene, polypropylene, polybutadiene, or polybutadiene/acrylonitrile copolymer, X is an ester, ether, amido or amino linkage, and n is 1-6. More specific examples are depicted generically as follows (i.e. the variables depicted in these structures are generic and would be understood by one of ordinary skill in the art but are not necessarily reflective of other variables defined or used herein):

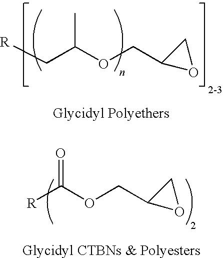

The formation of the separate liquid or gel phase comprising the modifying polymer appears to be driven by the disparity in polarities between the epoxy and modifying polymers. That is, despite their specific linking groups, the polymer backbones of the materials described herein for the modifying polymer have a greater aliphatic, non-polar character than do the aromatic, polyoxy networks associated with the epoxy systems. Differences in this “polarity character” are defined by the relative amounts of aromatic and aliphatic content of the epoxy and modifying polymers, respectively, as measured by the mole ratios of aromatic to aliphatic carbons within each polymer. Accordingly, together, it is preferred that the epoxy resins be at least 75 mole percent aromatic relative to the total molar content of the epoxy resin, more preferably at least 85%, and most preferably at least 95%, whereas the modifying polymer be at least 75 mole percent aliphatic relative to the total molar content of the modifying polymer, more preferably at least 85%, and most preferably at least 95%.

It should be understood that use of the term “modifying polymer” in relation to a given polymer structure refers to the portion of the polymer, oligomer, or precursor not including the terminal groups of that polymer, oligomer, or precursor (i.e. the “backbone” of the polymer). Sample backbone structures are shown in the following generic representations (i.e. the variables depicted in these structures are generic and would be understood by one of ordinary skill in the art but are not necessarily reflective of other variables defined or used herein):

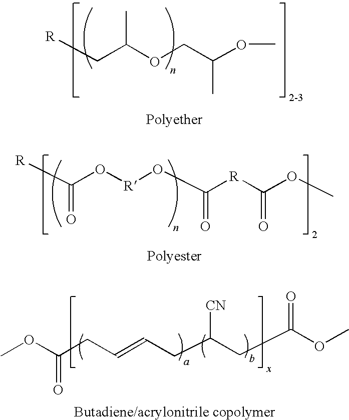

In the context of the present invention, the molecular weight of the modifying polymer is about 2000 daltons or greater, more preferably about 3000 daltons or greater, and most preferably about 4000 daltons or greater. With regard to the final polymer composite, there may be no upper limit as to the molecular weight characteristics of the modifying polymer, but for handling purposes, it is believed that 10,000 represents such a limit. Also, such a limit depends on the chemical nature of the modifying polymer. Accordingly, in some embodiments the modifying polymer may have a molecular weight between about 2000 to about 10,000 daltons, in other embodiments between about 3000 to about 10,000 daltons, and in yet other embodiments between about 4000 to about 10,000 daltons.

The relative amounts of the modifying polymer added to the epoxy resin is also considered in developing advantageous composites. Generally, the modifying polymer is present in no more than 40 weight percent based on the total weight of epoxy resin and the modifying polymer. In other embodiments, the modifying polymer is present in no more than 30 weight percent or no more than 20 weight percent based on the total weight of epoxy resin and the modifying polymer.

The term “polyesters” is intended to represent oligomers or polymers resulting from the condensation reactions of one or more poly-functional acids and alcohols, including the polyfunctional acids or alcohols deriving from polymerized fatty acids, and hydroxyacids. Polyhydroxyacids may include, for example, polyhydroxystearic or polyhydroxyoleic acids.

Unless otherwise indicated, the terms “polymerized fatty acid,” “dimer acid” (or dimerized fatty acid), and “trimer acid” (or trimerized fatty acid) as used herein carry their customary meaning and include polymerized products of unsaturated C₁₆ to C₂₀ fatty acids. Exemplary fatty acids are those derived from soybean oil, tall oil, corn oil, linseed oil, cottonseed oil, castor oil, kapok seed oil, rice bran oil, rapeseed oil, olive oil, sunflower oil, coconut oil, palm kernel oil, beef tallow, tallow and also compounds such as oleic acid, linoleic acid, linolenic acid and tall oil fatty acid. Dimer acids suitable for use in the practice of the present invention are described in U.S. Pat. Nos. 2,482,761 and 2,632,695, the disclosures of which are incorporated herein by reference. These dimer acids are typically prepared by condensing unsaturated carboxylic acids, which are typically mixtures themselves, through their olefinically unsaturated groups, in the presence of catalysts. The product of the polymerization is a complex mixture of relatively high molecular weight carboxylic acids, predominately 36-carbon dibasic acids and 54-carbon tribasic acids, with no single structure sufficient to characterize each. Component structures may be acyclic, cyclic (monocyclic or bicyclic) or aromatic. The distribution of the various structures depends upon the conditions of their manufacture. It is impractical and rather expensive to fully fractionate polymerized dimer and trimer acids. Accordingly, commercially available dimer acids often contain some trimer acid, and vice versa. Generally, mixtures containing between about 50 to about 90 percent by volume of the trimers are considered as trimer acids. Similarly, those mixtures containing greater than about 50 percent dimers are considered to be dimer acids. The relative amounts of dimer acid and trimer acid present can be determined by gas chromatography, according to methods well known in the art. Dimer and trimer acids are commercially available from a variety of vendors, including Henkel Corporation/Emery Group (e.g., Empol® 1008) and Croda (e.g., Pripol® 1004).

Similarly, U.S. Pat. Nos. 5,707,945 and 5,688,750, the disclosures of which are incorporated herein by reference, disclose the use of functionalized trimer acids, such as are available as Priolube® 3951, Priolube® 3952 and Priolube® 3955 from Croda.

The term “polyethers” is intended to represent polymers resulting from either the condensation reaction of glycols and/or the addition polymerization of alkylene oxides, for example ethylene oxide, propylene oxide, butylene oxide, higher carbon oxides, or mixtures thereof. “Alkoxylates” or “alkoxylation” refers to the general class of such polyoxides, or the process for preparing such polyoxides, respectively. Polyethers may be made such that the oxide monomer units are randomly distributed, or are added sequentially, the latter forming so-called block copolymers. Typically, such addition polymerizations are initiated with water or diols (for example, ethylene glycol), in which case the resulting alkoxide polymer is a di-functional diol, or using polyols (for example, glycerol, trimethylolpropane, or pentaerythritol), in which case the resulting alkoxide polymer is a tri-functional triol (as in the case of glycerol or trimethylolpropane), a tetra-functional tetra-ol (as in the case of pentaerythritol), or a hexa-functional hex-ol (as in the case of sorbitol). Each of these types of initiators may be used to prepare the alkoxylates referred to herein. It should also be appreciated that, while typically single molecular weights are cited for a given composition, the actual molecular weight for a given composition is actually a distribution of molecular weights, the specific nature of which depend on processing conditions. Accordingly, except where otherwise expressly specified herein, the cited molecular weights represent the weight averaged molecular weight.

It should also be understood by those skilled in the art that, while the modifying polymer has been defined using polyesters and polyethers as discrete and individual chemical classes, the present invention may include those structures comprising distributed diacids and alcohols, polyols, or polyethers as well.

The term “polybutadiene” is intended to represent oligomers or polymers resulting from the addition polymerization of butadiene, C₄H₁₀, defined in its conventional sense, but also may include the more general polydiene family—that is, the oligomers or polymers resulting from the addition polymerization of the wider range of diene precursors, all of which may be used in the present invention.

Typically, the mixture of the glycidyl terminated modifying polymer and liquid epoxy resin remain in intimate contact prior to polymerization. Therefore, “mixing” of the epoxy resins with the glycidyl terminated modifying polymer means that the glycidyl terminated modifying polymer is in intimate contact with the epoxy resin, preferably at least a highly dispersed liquid-liquid emulsion, most preferably in terms that the glycidyl terminated modifying polymer is completely or substantially dissolved within the epoxy resin. “Substantially” dissolved means that the mixture is visually clear, suggesting a single liquid phase or microemulsion. In other embodiments, the glycidyl terminated modifying polymer is so highly dispersed in the epoxy resin so as to form a homogeneous dispersion.

One benefit of the present invention is that, in some cases, the viscosity of the mixture does not increase dramatically, relative to the viscosity of the formulated or unformulated epoxy resin, and in some cases, it is reduced. That is, in contrast to certain circumstances where the presence of non-glycidated modified polymers can increase viscosities as much as three to four times that of the formulated epoxy resin, the data herein shows that presence of the glycidyl terminated modifying polymers increase the viscosities less than two times as much.

Another benefit of the present invention is that it provides composite polymers with improved toughness while maintaining the glass transition temperatures (Tg's) of the epoxy system. For example, in the context of the present invention, an epoxy polymer composite whose Tg is not more than 25° C. lower than the epoxy system without the modifying polymer is considered beneficial and generally commercially acceptable. Accordingly, an epoxy polymer composite of the present invention having a Tg of not more than 15° C. lower than the epoxy system without the modifying polymer is preferred and those with a Tg of not more than 5° C. lower is more preferred.

Another benefit of the present invention is that the resulting composite polymers maintain good adhesion. Adhesion is generally measured in terms of adhesion tensile shear and T-Peel strength, measured according to ASTM D1002 and ASTM D1876, respectively. The preferred embodiments of the present invention provide composites in which both adhesion tensile shear and T-Peel strength are independently no less than 80% of the corresponding values for the epoxy system without the modifying polymer. In other emodiments the adhesion tensile shear and T-Peel strength are independently equivalent to the corresponding values for the epoxy system without the modifying polymer, and in other embodiments the values are independently 20% higher than the corresponding values for the epoxy system without the modifying polymer.

In addition, the methods herein also utilize various additives to achieve other desired results, such as curing agents, catalysts, accelerators, dyes, stabilizers, and solid fillers (for example, clays, glass beads, fumed silica, glass fibers, carbon powder, carbon fibers, silicones, or mixtures thereof).

### EXAMPLES

The following examples illustrate specific embodiments and applications of the present invention. In all examples, all parts and percentages are by weight, and temperatures are in degrees Celsius unless otherwise noted. In the examples, Epoxy equivalent weights, EEW, are measured by titration, according to ASTM D1652, with results expressed in grams per equivalent; glass transition temperatures (Tg) are measured by differential scanning calorimetry, according to ASTM E1356; viscosities are measured at 25° C. using ASTM D2393, with results typically measured in centipoise (cP); lap shear (adhesive tensile shear) is measured by ASTM D1002, using 1″×4″ phosphate treated cold rolled steel substrates, with results typically measured in psi; T-Peel adhesions are measured by ASTM D1876, again using 1″×4″ phosphate treated cold rolled steel substrates, with results typically measured in lb_{f}/linear inch; and fracture toughness (K1c and G1c) are measured by ASTM D5045, with results typically calculated in megapascals (MPa).

It is believed the chemical formulae and names used herein correctly and accurately reflect the underlying chemical compounds. However, the nature and value of the present invention does not depend upon the theoretical correctness of these formulae, in whole or in part. Thus, it is understood that the formulae used herein, as well as the chemical names attributed to the correspondingly indicated compounds, are not intended to limit the invention in any way. Additional objects, advantages, and novel features of this invention will become apparent to those skilled in the art upon examination of the following examples thereof, which are not intended to be limiting.

### Preparation of the Glycidyl Ethers/Esters

Preparation of Glycidyl Ethers of Butadiene and Butadiene/Acrylonitrile Copolymers

Methods for preparing glycidyl ethers onto carboxy terminated butadiene or butadiene/acrylonitrile copolymers are generally described in U.S. Pat. Nos. 2,772,296, 3,208,980 and 3,784,525, and British Patent 844, 033, and the methodologies described by these patents are incorporated by reference herein.

### Example 1

Using procedures derived from U.S. Pat. No. 3,784,525 for glycidating polybutadiene and polybutadiene/acrylonitrile copolymers, 543 grams of a carboxyl-terminated polybutadiene g(Mn=4,200; 0.13 mol; available as Hypro™ 2000X162 from Emerald Performance Materials) and 500 grams of epichlorohydrin (MW=92.5; 5.4 mol) were heated under nitrogen in a 2 L flask to 90° C., after which 1.2 gram tetramethyl ammonium chloride in 11.2 grams of water were added, and the mixture stirred at this temperature for 1 hour. The temperature was reduced to ca. 70° C., 22.4 grams of 50% NaOH was added, and the pressure was reduced to ca. 130 mm Hg. After distilling the water from the mixture, and cooling to ca. 40° C., the mixture was diluted with another 800 grams of epichlorohydrin, and the entire mixture was vacuum filtered three times through Celite to remove the salt. The excess epichlorohydrin and water was vacuum distilled out at ca. 45° C. and ca. 40 mm Hg, and the mixture cooled. The resulting mixture had a viscosity of 35,000 cP.

### Examples 2-4

Glycidyl ether adducts of carboxyl-terminated polybutadiene/acrylonitrile copolymers were prepared using essentially the same procedure as used in Example 1. The characteristics of the starting materials and the final glycidated adducts are presented in Table 1:

TABLE 1

| | Example 1 | Example 2 | Example 3 | Example 4 |
|---|---|---|---|---|
| Starting Material* | Hypro ™ | Hypro ™ | Hypro ™ | Hypro ™ |
| | 2000X162 | 1300X31 | 1300X8 CTBN | 1300X13 |
| | CTB | CTBN | | CTBN |
| Acrylonitrile | 0 | 10 | 18 | 26 |
| Content, %** | | | | |
| Brookfield | 60,000 | 60,000 | 135,000 | 500,000 |
| Viscosity, cP @ | | | | |
| 27° C.** | | | | |
| Functionality** | 1.9 | 1.9 | 1.8 | 1.8 |
| Molecular | 4,200 | 3,800 | 3,550 | 3,150 |
| Weight, Mn** | | | | |
| Viscosity of | 35,000 | 63,000 | 108,400 | 576,000 |
| glycidated polymer | | | | |
| precursor, cP @ | | | | |
| 25° C. | | | | |
| Epoxy Equivalent | 2278 | 2215 | 2144 | 2204 |
| Weight, EEW, | | | | |
| grams/equivalent | | | | |

*Available from Emerald Performance Materials;
**Nominal values of starting polymer precursors

### Preparation of Glycidyl Ethers of Polyethers

The glycidyl ethers of polyethers were prepared from the reaction of the representative polyglycol with epichlorohydrin in the presence of a Lewis acid catalyst, followed by dehydrochlorination, per methods described in U.S. Pat. Nos. 2,094,489 and 3,024,273, which are incorporated by reference herein.

### Example 5

765 grams of propoxylated glycerol (Mn=1500, 0.51 mol, available as Macol-52) were dissolved in 411 grams xylene, to which 6 grams of SnCl₄ in 20 grams of xylene was then added, and the mixture was heated under nitrogen to ca. 55° C. The slow addition of 167 grams (1.8 mol) of epichlorohydrin resulted in a slight exotherm; the mixture was held at 55-60° C. for 2.5 hours, and then allowed to cool to 40° C. Vacuum distillation at 28 inches Hg vacuum, with temperature increasing from 40° to 110° C., resulted in quantitative recovery of the xylene and liberated water. After cooling the mixture again to 55-60° C., 1 gram of tributylmethylammonium chloride and 133 gram of 25% NaOH and 50 grams of water. After mixing for 30 minutes the brine solution is phase separated. A second treatment with 107 grams of 25% NAOH and 30 grams of water is done followed by mixing for 30 minutes and the brine phase separated. A third treatment with 160 grams of 25% NaOH and 25 grams is done followed by 30 minute mixing and phase separation with removal of the brine solution. The organic layer is then washed with a solution containing 30 grams of sodium sulphate, 10 grams of mono sodium phosphate, 5 grams of disodium phosphate and 160 grams of water followed by the addition of 100 grams of xylene then phase separated to remove wash solution. The residual water and xylene is distilled off under reduced pressure distillation. The resulting product mixture had a viscosity of 270 cP, and an EEW of 675.

### Examples 6-8

Glycidyl ether adducts of three other polypropylene glycols were prepared using essentially the same procedure as used in Example 5. The characteristics of the starting materials and the final glycidated adducts are presented in Table 2.

TABLE 2

| | Example 5 | Example 6 | Example 7 | Example 8 |
|---|---|---|---|---|
| Starting Material | 76% Bayer ® | Arcol ® | Arcol ® | Polyglycol |
| | LHT-112 | LG-56** | LG-42** | 4000* |
| | 24% Arcol ® | | | |
| | LG-56** | | | |
| Functionality | triol | triol | triol | Diol |
| Molecular | 1500 | 3000 | 4000 | 4000 |
| Weight*** | | | | |
| Viscosity of | 270 | 400 | 625 | 912 |
| glycidated polymer | | | | |
| precursor, | | | | |
| cP @ 25° C. | | | | |
| Epoxy Equivalent | 675 | 1228 | 1697 | 2608 |
| Weight, EEW, | | | | |
| grams/equivalent | | | | |

*Available from The Dow Chemical Company.
**Available from Bayer.
***Nominal values of starting materials.

### Preparation of Glycidyl Ethers of Polyesters

Methods for preparing glycidyl ethers onto carboxy terminated carboxy terminated polyesters are generally described in U.S. Pat. Nos. 2,772,296, 3,208,980, 3,057,809, and 3,784,525, and British Patent 844, 033, and the methodologies described by these patents are incorporated by reference herein.

### Example 9

500 grams of polyester polymer (Mn=3000, 0.17 mol, available as Priplast 2104 from Croda), 200 grams of epichlorohydrin (2.16 mol), and 1 gram of tetramethyl ammonium chloride in 1 gram of water was heated to ca. 88° C. and stirred under nitrogen for one hour. The mixture was cooled to 70° C. and set up for vacuum distillation at 125-130 mm Hg. A total of 57 grams of 50% NaOH is added dropwise and the present and generated is removed azeotropically. A total of 14 grams of water was distilled off. The mixture was diluted with 200 grams of epichlorohydrin and filtered through Celite to remove the NaCl. The process of diluting with epichorohydrin and filtering through Celite was repeated twice. Excess epichlorohydrin was removed by vacuum distillation to yield a glycidated adduct with a viscosity of 38,500 cP and an EEW of 1687.

### Example 10

Bisphenol A adducts, where indicated as made using conventional industry techniques, below, were prepared according to the following example. After a mixture of 60 parts Bisphenol A epoxy resin and 40 parts of a modifying polymer were heated to about 120° C., 0.5 parts of triphenylphosphine oxide were added. The mixture was held at temperature, with agitation for 30 minutes, then cooled to ambient temperature. The composition was used as prepared.

### Preparation of Epoxy Composites

In the Examples provided below, the model formulation for the study employed liquid Bisphenol A epoxy resin, dicyandiamide as curative, and Omicure U52M as accelerator. Fumed silica was added to aid in maintaining the suspension. The base conditions were using:
Bisphenol A liquid epoxy resin, available as DER 331 from The Dow Chemical Company 15 weight % glycidyl terminated modifying polymer based on the epoxy resin 6 parts by weight per hundred parts resin of dicyandiamide, available as DDA 10 from CVC Thermoset Specialties, Inc.
3 parts by weight per hundred parts resin of Omicure U52M available from CVC Thermoset Specialties, Inc., and
2 parts by weight per hundred parts resin of M-5 fumed silica available as Cabosil M-5 from Cabot Corporation.

These ingredients were mixed together at room temperature using a cowls mixer. After mixing, the mixture was applied to the phosphate coated cold rolled steel substrates (in case of adhesion testing) or into appropriate molds for testing, and cured at 125° C. for 2 hours.

Where appropriate, comparisons are made to standard industry formulations. In particular, standard industry practice is to pre-react, or “adduct” the modifying polymer terminated with proton donating functional groups with low molecular weight Bisphenol A epoxy. Where appropriate, comparisons are made to samples so-prepared. Note here that the corresponding Bisphenol A adduct actually contains about 35 to 40 weight percent Bisphenol A (and so 60 to 65 wt % modifying polymer). In the composite formulations, corrections were made to maintain the polymer content constant in the matrix. That is, a mixture of 6.3 parts epoxy resin with 3.7 parts adducted modifying polymer is equivalent, in final form, to 8.5 parts epoxy resin and 1.5 parts of unadducted modifying polymer. However, in presenting these Examples, the actual charge ratios are cited.

### Comparative Example A

A mixture of:

10 parts Bisphenol A liquid epoxy resin,

0.6 parts of dicyandiamide,

0.3 parts of Omicure U52M, and

0.2 parts of M-5 fumed silica was mixed together at room temperature using a cowls mixer, and then cured at 125° C. for 2 hours.

The properties of the cured resin are shown in Tables 3A & B, 4, and 5 as Comparative Example A.

Preparation of Epoxy Composites Based on Glycidyl Ethers of Butadiene and Butadiene/Acrylonitrile Copolymers

### Comparative Examples B & C

A mixture of:

8.5 parts Bisphenol A liquid epoxy resin,

1.5 parts of unmodified carboxyl terminated butadiene-acrylonitrile (CTBN) polymers,

0.6 parts of dicyandiamide,

0.3 parts of Omicure U52M, and

0.2 parts of M-5 fumed silica was mixed together at room temperature using a cowls mixer, and then cured at 125° C. for 2 hours.

Comparative Example B corresponds to the composite which results when the CTBN polymer has a nominal acrylonitrile content of 18%, a viscosity of 135,000 cP, and a molecular weight, Mn, of 3,550 (available as Hypro™ 1300X8 CTBN).

Comparative Example C corresponds to the composite which results when the CTBN polymer has a nominal acrylonitrile content of 26%, a viscosity of 500,000 cP, and a molecular weight, Mn, of 3,150 (available as Hypro™ 1300X13 CTBN).

The properties of the cured composites are shown in Table 3A.

### Comparative Examples D & E

A mixture of:

6.3 parts Bisphenol A liquid epoxy resin,

3.7 parts of carboxyl terminated butadiene-acrylonitrile (CTBN) polymers adducted with Bisphenol A,

0.6 parts of dicyandiamide,

0.3 parts of Omicure U52M, and

0.2 parts of M-5 fumed silica was mixed together at room temperature using a cowls mixer, and then cured at 125° C. for 2 hours.

The Bisphenol A adducts were prepared using conventional industry techniques, as described in Example 10.

Comparative Example D corresponds to the composite which results when the CTBN polymer corresponding to Comparative Example B was pre-reacted (“adducted”) with Bisphenol A, available as HyPox RA 840 from CVC Specialty Chemicals, Inc.

Comparative Example E corresponds to the composite which results when the CTBN polymer corresponding to Comparative Example C was pre-reacted (“adducted”) with Bisphenol A, available as HyPox RA 1340 from CVC Specialty Chemicals, Inc.

The properties of the cured composites are shown in Table 3A.

### Examples A-D

A mixture of:

8.5 parts Bisphenol A liquid epoxy resin

1.5 parts of glycidyl esters of carboxyl terminated butadiene-acrylonitrile (CTBN) polymers

0.6 parts of dicyandiamide

0.3 parts of Omicure U52M, and

0.2 parts of M-5 fumed silica was mixed together at room temperature using a cowls mixer, and then cured at 125° C. for 2 hours.

Example A corresponds to the composite which results when the glycidyl ester described above in Example 1 was used.

Example B corresponds to the composite which results when the glycidyl ester described above in Example 2 was used.

Example C corresponds to the composite which results when the glycidyl ester described above in Example 3 was used. The modifying polymer of Example C corresponds to those of Comparative Examples B and D.

Example D corresponds to the composite which results when the glycidyl ester described above in Example 4 was used. The modifying polymer of Example D corresponds to those of Comparative Examples C and E.

The properties of the cured composites are shown in Table 3B.

TABLE 3A

| | Comparative | Comparative | Comparative | Comparative | Comparative |
|---|---|---|---|---|---|
| | Example A | Example B | Example C | Example D | Example E |
| Nominal | N/A | 135,000 | 500,000 | 135,000 | 500,000 |
| Viscosity of Un- | | | | | |
| Adducted | | | | | |
| Modifying | | | | | |
| Polymer*, cP @ | | | | | |
| 25° C. | | | | | |
| Nominal | N/A | 3,550 | 3,150 | 3,550 | 3,150 |
| Molecular | | | | | |
| Weight of Un- | | | | | |
| Adducted | | | | | |
| Modifying | | | | | |
| Polymer* | | | | | |
| Viscosity of Pre- | 38,900 | 63,200 | 104,000 | 117,500 | 157,000 |
| Polymerized | | | | | |
| Mixture, cP @ | | | | | |
| 25° C. | | | | | |
| Lap shear, psi | 1,242 | 1,487 | 2,670 | 2,211 | 2,421 |
| T-Peel, pli | 7.89 | 17.8 | 21.1 | 17.3 | 19.0 |
| Composite Tg, | 134.8 | 123.7 | 120.4 | 117.7 | 112.6 |
| ° C. | | | | | |
| Composite K1c, | 0.56 | 1.28 | 1.27 | 1.33 | 1.65 |
| MPa | | | | | |

TABLE 3B

| | Comparative | | | | |
|---|---|---|---|---|---|
| | Example A | Example A | Example B | Example C | Example D |
| Nominal Viscosity of Un- | N/A | 60,000** | 60,000** | 135,000 | 500,000 |
| Adducted Modifying | | | | | |
| Polymer*, cP @ 25° C. | | | | | |
| Nominal Molecular Weight of | N/A | 4,200 | 3,800 | 3,550 | 3,150 |
| Un-Adducted Modifying | | | | | |
| Polymer* | | | | | |
| Viscosity of Pre-Polymerized | 38,900 | 40,200 | 50,000 | 60,600 | 68,900 |
| Mixture, cP @ 25° C. | | | | | |
| Lap shear, psi | 1,242 | 2,100 | 2,381 | 2,477 | 2,468 |
| T-Peel, pli | 7.89 | 13.4 | 28.4 | 20.9 | 21.3 |
| Composite Tg, ° C. | 134.8 | 126.2 | 122.3 | 124.0 | 123.6 |
| Composite K1c, MPa | 0.56 | 1.38 | 1.35 | 1.13 | 1.43 |

### Preparation of Epoxy Composites Based on Glycidyl Ethers of Polyethers

For the polyether backbone the end group functionality was restricted to glycidated polyether glycols. Attempts were made using the glycol ethers themselves but as they do not react into the formulation during cure they left the specimens oily and difficult to handle.

### Comparative Example F

A mixture of:

8.5 parts Bisphenol A liquid epoxy resin,

1.5 parts of polypropylene glycol, with molecular weight of 425 daltons, available as Polyglycol P245 from The Dow Chemical Company,

0.6 parts of dicyandiamide,

0.3 parts of Omicure U52M, and

0.2 parts of M-5 fumed silica was mixed together at room temperature using a cowls mixer, and then cured at 125° C. for 2 hours.

The properties of the cured composite is shown in Table 4.

### Examples E-H

A mixture of:

8.5 parts Bisphenol A liquid epoxy resin

1.5 parts of glycidyl ether of polypropylene glycol,

0.6 parts of dicyandiamide

0.3 parts of Omicure U52M, and

0.2 parts of M-5 fumed silica was mixed together at room temperature using a cowls mixer, and then cured at 125° C. for 2 hours.

Example E corresponds to the composite which results when the glycidyl ether described above in Example 5 was used (glycerol initiated, 2000 MW).

Example F corresponds to the composite which results when the glycidyl ether described above in Example 6 was used (glycerol initiated, 3000 MW).

Example G corresponds to the composite which results when the glycidyl ether described above in Example 7 was used (glycerol initiated, 4000 MW).

Example H corresponds to the composite which results when the glycidyl ether described above in Example 8 was used (water initiated diol, 4000 MW)

The properties of the cured composites are shown in Table 4.

TABLE 4

| | Comparative | Comparative | | | | |
|---|---|---|---|---|---|---|
| | Example A | Example F | Example E | Example F | Example G | Example H |
| Modifier | None | 425 | 2000 | 3000 | 4000 | 4000 |
| MW | | | | | | |
| Viscosity of | 38,900 | 11,700 | 13,225 | 21,050 | 26,000 | 26,000 |
| Pre- | | | | | | |
| Polymerized | | | | | | |
| Mixture, cP | | | | | | |
| @ 25° C. | | | | | | |
| Lap shear, | 1,242 | 1,844 | 2,143 | 1,690 | 1,302 | 1,131 |
| psi | | | | | | |
| T-Peel, pli | 7.89 | 8.3 | 13.37 | 11.85 | 10.74 | 8.55 |
| Composite | 134.8 | 89.72 | 106.34 | 116.78 | 118.11 | 120.64 |
| Tg, ° C. | | | | | | |
| Composite | 0.56 | 2.45 | 1.91 | 1.56 | 1.26 | 1.29 |
| K1c, MPa | | | | | | |
| Composite | | transparent | Slightly | | | Opaque |
| Appearance | | | translucent | | | |

### Preparation of Epoxy Composites Based on Glycidyl Esters of Polyesters

### Comparative Examples G & H

A mixture of:

6.3 parts Bisphenol A liquid epoxy resin,

3.7 parts of dimerized fatty acid,

0.6 parts of dicyandiamide,

0.3 parts of Omicure U52M, and

0.2 parts of M-5 fumed silica was mixed together at room temperature using a cowls mixer, and then cured at 125° C. for 2 hours.

Comparative Example G corresponds to the composite which results when the dimerized fatty acid had a molecular weight of 1500, available from Croda as Priplast® 2101.

Comparative Example H corresponds to the composite which results when the dimerized fatty acid had a molecular weight of 3000, available from Croda as Priplast® 2014.

The properties of the cured composites are shown in Table 5.

### Comparative Examples I & J

A mixture of:

6.3 parts Bisphenol A liquid epoxy resin,

3.7 parts of “adducted” ester of dimerized fatty acid,

0.6 parts of dicyandiamide,

0.3 parts of Omicure U52M, and

0.2 parts of M-5 fumed silica was mixed together at room temperature using a cowls mixer, and then cured at 125° C. for 2 hours.

Comparative Example I corresponds to the composite which results when the dimerized fatty acid corresponding to Comparative Example G was pre-reacted (“adducted”) with Bisphenol A, using conventional industry methods, as described in Example 10.

Comparative Example J corresponds to the composite which results when the dimerized fatty acid corresponding to Comparative Example H was pre-reacted (“adducted”) with Bisphenol A, using conventional industry methods, as described in Example 10.

The properties of the cured composites are shown in Table 5.

### Example I

A mixture of:

8.5 parts Bisphenol A liquid epoxy resin

1.5 parts of glycidyl ester of dimerized fatty acid

0.6 parts of dicyandiamide

0.3 parts of Omicure U52M, and

0.2 parts of M-5 fumed silica was mixed together at room temperature using a cowls mixer, and then cured at 125° C. for 2 hours.

The glycidyl ester of the dimerized fatty acid corresponds to Example 9; the modifying polymer has the same molecular weight as Comparative Examples H & J.

The properties of the cured composites are shown in Table 5.

TABLE 5

| | Comparative | Comparative | Comparative | Comparative | Comparative | |
|---|---|---|---|---|---|---|
| | Example A | Example G | Example H | Example I | Example J | Example I |
| Viscosity of | 38,900 | 157,000 | 117,500 | 106,000 | 96,000 | 47,800 |
| Pre- | | | | | | |
| Polymerized | | | | | | |
| Mixture, cP | | | | | | |
| @ 25° C. | | | | | | |
| Lap shear, | 1,242 | 2,421 | 2,211 | 1,507 | 2,317 | 1,914 |
| psi | | | | | | |
| T-Peel, pli | 7.89 | 19.01 | 17.3 | 15.65 | 17.5 | 17.6 |
| Composite | 134.8 | 112.6 | 117.7 | 106.1 | 113.0 | 116.9 |
| Tg, ° C. | | | | | | |
| Composite | 0.56 | 1.65 | 1.33 | 2.07 | 1.93 | 1.80 |
| K1c, MPa | | | | | | |

In the present disclosure the singular forms “a,” “an,” and “the” include the plural reference, and reference to a particular numerical value includes at least that particular value, unless the context clearly indicates otherwise. Thus, for example, a reference to “a material” is a reference to one or more of such materials and equivalents thereof known to those skilled in the art, and so forth. When values are expressed as approximations, by use of the antecedent “about,” it will be understood that the particular value forms another embodiment. Where present, all ranges are inclusive and combinable.

The disclosures of each patent, patent application, and publication cited or described in this document are hereby incorporated herein by reference, in their entirety.

What is claimed:

1. A method for preparing a toughened epoxy polymer composite system, comprising
reacting epichlorohydrin with a modifying polymer having at least two terminal proton donating functional groups to terminate the modifying polymer with at least two glycidyl ethers,
mixing a liquid epoxy resin with the glycidyl terminated modifying polymer, and
copolymerizing the epoxy resin and the glycidyl terminated modifying polymer such that a liquid or gel phase comprising the modifying polymer separates from a solidified epoxy polymer to form the epoxy polymer composite system, and
wherein the modifying polymer has a molecular weight of about 2000 daltons or greater.

2. The method of claim 1, wherein the proton donating functional groups comprise —COOH, —OH, —NH(R), or —C(O)NH(R), wherein R is H or C₁₋₄ alkyl.

3. The method of claim 1 wherein the modifying polymer has a molecular weight of about 3000 daltons or greater.

4. The method of claim 1 wherein the modifying polymer has a molecular weight of between about 2000 to about 10,000 daltons.

5. The method of claim 1 wherein the glass transition temperature of the composite system is no lower than about 25° C. below the glass transition temperature of the composite system in the absence of the modifying polymer.

6. The method of claim 1, wherein the modifying polymer is present in no more than 40 weight percent based on the total weight of epoxy resin and the modifying polymer.

7. The method of claim 1, wherein the modifying polymer is present in no more than 20 weight percent based on the total weight of epoxy resin and the modifying polymer.

8. The method of claim 1, wherein the glycidyl terminated modifying polymer is substantially dissolved in the liquid epoxy resin prior to co-polymerization.

9. The method of claim 1, wherein the liquid epoxy resin comprises a glycidated Bisphenol A or Bisphenol F.

10. The method of claim 1, wherein the modifying polymer is of the general formula 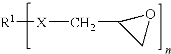
wherein R¹ comprises a polyether, polyester, polyacrylic, polyamide, polyolefin, polydiene, or polydiene/acrylonitrile copolymer, X is an ester, ether, amido or amino linkage, and n is 1-6.

11. The method of claim 10, wherein R¹ comprises a polyether, polyester, polybutadiene, or polybutadiene/acrylonitrile copolymer.

12. The method of claim 10, wherein R¹ is an alkoxylated diol or polyol.

13. The method of claim 12, wherein the polyol is a glycerol, trimethylol propane, pentaerythritol, or sorbitol.

14. The method of claim 12, wherein the alkoxylate moiety comprises repeating C₂-C₄ oxide units, or mixtures thereof.

15. The method of claim 10, wherein R¹ is a butadiene or butadiene/acrylonitrile copolymer.

16. The method of claim 10, wherein R¹ comprises the condensation reaction product of polymerized fatty acids, linear C₁-C₆ dioic acids, and C₁-C₆ diols.

17. The method of claim 16, wherein the polymerized fatty acids are dimerized or trimerized fatty acid.

18. The method of claim 1, wherein the epoxy polymer composite system further comprises one or more solid fillers.

19. The method of claim 18, wherein the one or more solid fillers comprise clays, glass beads, fumed silica, glass fibers, carbon powder, carbon fibers, silicones, or mixtures thereof.

20. The method of claim 1, wherein the mixture of the epoxy resin and the glycidyl terminated modifying polymer comprises a polymerization catalyst, curing agent, hardening agent, dye, antioxidant, or stabilizer.

21. The method of claim 20, wherein the curing agent is dicyandiamide.

22. An epoxy polymer composite system prepared by the method of claim 1.
